(19) United States
(12) Patent Application Publication
(10) Pub. No.: US 2023/0360567 A1
(43) Pub. Date: Nov. 9, 2023

(54) VIRTUAL REALITY DISPLAY SYSTEM

(71) Applicant: Meta Platforms Technologies, LLC, Menlo Park, CA (US)

(72) Inventor: Dongmin YANG, San Jose, CA (US)

(73) Assignee: Meta Platforms Technologies, LLC, Menlo Park, CA (US)

(21) Appl. No.: 17/989,145

(22) Filed: Nov. 17, 2022

Related U.S. Application Data
(60) Provisional application No. 63/339,735, filed on May 9, 2022.

(51) Int. Cl. G09G 3/00; G02B 27/01

(52) U.S. Cl. CPC G09G 3/002; G02B 27/0172; G09G 3/003; G02B 2027/0138; G02B 2027/0178

(57) ABSTRACT

A near-eye display device may include a camera to track location of an eye pupil center; a projection light source to provide a collimated beam; and a micromirror array with adjustable micromirror pixels, for each eye of a user wearing the near-eye display device. A processor may determine a first coordinate set for a point on a 3D virtual object and a second coordinate set for a center of the pupil; select a micromirror pixel based on the first and second coordinate sets; determine a tilt angle for the selected micromirror pixel based on the first and second coordinate sets and a location of the projection light source; set the selected micromirror pixel to determined tilt angle; set a direction of the projection light source to a center of the micromirror pixel; and cause the projection light source to transmit a collimated beam to the center of the micromirror pixel.

### CROSS REFERENCE TO RELATED APPLICATIONS

This patent application claims the benefit of U.S. Provisional Pat. Application Serial No. 63/339,735 filed on May 9, 2022. The disclosures of the above application are hereby incorporated by reference for all purposes.

### TECHNICAL FIELD

This patent application relates generally to near-eye display devices, and more specifically, to providing virtual reality (VR) content, augmented reality (AR) content, and/or mixed reality (MR) content in a near-eye display device with an angle controllable micromirror array.

### BACKGROUND

With recent advances in technology, prevalence and proliferation of content creation and delivery has increased greatly in recent years. In particular, interactive content such as virtual reality (VR) content, augmented reality (AR) content, mixed reality (MR) content, and content within and associated with a real and/or virtual environment (e.g., a “metaverse”) has become appealing to consumers.

Virtual reality (VR) content, augmented reality (AR) content, or mixed reality (MR) content may be presented through near-eye display devices such as head-mounted displays (HMDs), smart glasses, and similar ones. While providing advantages such as portability, handsfree assistance, etc., near-eye display devices may have a number of challenges such as user eye fatigue, narrow field of view (FOV), image coloring, resolution, and brightness. Near-eye display devices may also be subject to stray lights.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a perspective view of a near-eye display 100 in the form of a pair of glasses, according to an example.

FIGS. 2A-2C illustrate an architecture for near-eye displays with individual mirror angle controllable micromirror array, according to an example.

FIG. 3A illustrates an electro-mechanically controllable micromirror array, according to an example.

FIG. 3B illustrates a microfluidic tunable prism that may be used as a mirror angle controllable micromirror array, according to an example.

FIG. 4 illustrates a flowchart of a method for providing virtual reality (VR) content, augmented reality (AR) content, or mixed reality (MR) content through a near-eye display with mirror angle control, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

As used herein, a “near-eye display” may refer to any display device (e.g., an optical device) that may be in close proximity to a user’s eye. As used herein, “artificial reality” may refer to aspects of, among other things, a “metaverse” or an environment of real and virtual elements and may include use of technologies associated with virtual reality (VR), augmented reality (AR), and/or mixed reality (MR). As used herein, a “user” may refer to a user or wearer of a “near-eye display.”

Some near-eye display devices may display two stereoscopic images, one image to each eye, at a time. In augmented reality (AR) or mixed reality (MR) applications, the artificial (virtual) images may be superimposed onto an image of the user’s environment through transparent or semi-transparent displays or by capturing the environment image through a camera and superimposing the images. Lenses and similar optical components may be placed between the images and eyes to allow the eyes to focus on the images as if they appear at a far distance.

The projection and focusing techniques may, however, cause eye fatigue and discomfort, reduce stereo acuity, and/or distort a perceived depth. In some cases, a field of view (FOV) of the near-eye display may not be sufficiently wide for augmented reality applications. Furthermore, image color fringing at edges of an image may occur along with reduced resolution and/or brightness. Stray lights control (e.g., ghost images and flares) may also be a challenge.

In some examples of the present disclosure, virtual reality (VR) content, augmented reality (AR) content, and/or mixed reality (MR) content may be provided in a near-eye display with an angle controllable micromirror array. For each point on a two-dimensional (2D) image, a virtual object location may be computed for both eyes. Each pupil’s center location may be tracked, and the computed locations aligned to each pupil’s center location to determine a mirror pixel to be used. Using a projector location, a pupil center location, and the mirror pixel’s center as three reference points, a tilt angle for the mirror pixel may be determined to reflect the projection to each eye.

In some examples, the selected mirror pixel may be set to the determined tilt angle, and the projector may be aimed at the mirror pixel’s center. The mirror pixel may reflect the projected image point to the eyes, as a result of which, the user’s brain may create a stereo image point. The system may scan each point on the 2D image similarly projecting the entire image to the eyes.

Accordingly, the eyes may focus at infinity even if objects in the virtual 3D image space are meant to be at close distance because the projection light is collimated light. Thus, the eyes may not need to frequently refocus preventing fatigue and associated headache. A field of view (FOV) of the near-eye display may be as big as a coverage area of the micromirror arrays. Mirror reflections may not cause image fringing. Furthermore, image resolution may depend on micromirror pixel size. Thus, smaller mirror pixel size may result in improved resolution. Point-to-point projection and reflection may also minimize stray lights. In some examples, the micromirror array may be made semi-transparent for use in augmented reality (AR) or mixed reality (MR) applications. Alternatively, transparent microfluid tunable mirror or prism arrays may also be used. Instead of point scanning, line scanning may be used. Moreover, multiple projectors may scan for different mirror zones to increase a scanning speed. Other benefits and advantages may also be apparent.

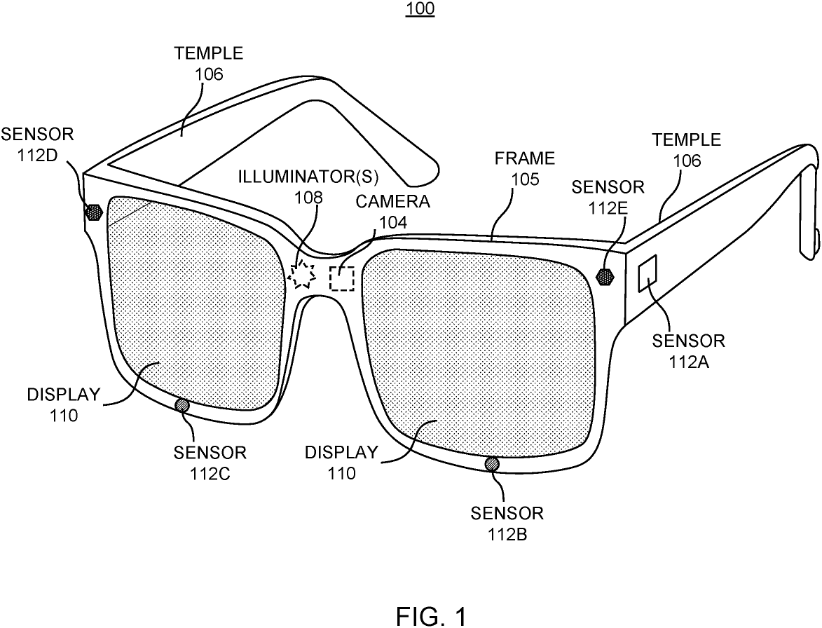

FIG. 1 illustrates a perspective view of a near-eye display 100 in the form of a pair of glasses, according to an example. In some examples, the near-eye display 100 may be an implementation of a wearable device, specifically, a head-mounted display (HMD) device configured to operate as a virtual reality (VR) display, an augmented reality (AR) display, and/or a mixed reality (MR) display.

In some examples, the near-eye display 100 may include a frame 105, temples 106, and a display 110. The display 110 may be configured to present media or other content to a user and may include display electronics and/or display optics. For example, the display 110 may include a transparent liquid crystal display (LCD) display panel, a transparent light-emitting diode (LED) display panel, or a transparent optical display panel (e.g., a waveguide display assembly). Other optical components may include waveguides, gratings, lenses, mirrors, etc. Electrical components may include sensors 112A - 112E, camera 104, illuminator(s) 108, etc. In some examples, the temples 106 may include embedded battery(ies) (not shown) to power the electrical components.

In some examples, the various sensors 112A - 112E may include any number of depth sensors, motion sensors, position sensors, inertial sensors, and/or ambient light sensors, as shown. In some examples, the various sensors 112A - 112E may include any number of image sensors configured to generate image data representing different fields of views in one or more different directions. In some examples, the various sensors 112A- 112E may be used as input devices to control or influence the displayed content of the near-eye display 100, and/or to provide an interactive virtual reality (VR), augmented reality (AR), and/or mixed reality (MR) experience to a user of the near-eye display 100. In some examples, the various sensors 112A - 112E may also be used for stereoscopic imaging or other similar application. A virtual reality engine (implemented on the near-eye display 100 or on another computing device and wirelessly coupled to the near-eye display 100) may execute applications within the near-eye display 100 and receive depth information, position information, acceleration information, velocity information, predicted future positions, or any combination thereof of the near-eye display 100 from the various sensors 112A -112E.

In some examples, the near-eye display 100 may further include one or more illuminators 108 to project light into a physical environment. The projected light may be associated with different frequency bands (e.g., visible light, infra-red light, ultra-violet light, etc.), and may serve various purposes. In some examples, the one or more illuminator(s) 108 may be used as locators. Each of the locators may emit light that is detectable by an external imaging device. This may be useful for the purposes of head tracking or other movement/orientation. It should be appreciated that other elements or components may also be used in addition or in lieu of such locators.

In some examples, the near-eye display 100 may also include a camera 104 or other image capture unit. The camera 104, for instance, may capture images of the physical environment in the field of view. In some instances, the captured images may be processed, for example, by a virtual reality engine (implemented on the near-eye display 100 or on another computing device and wirelessly coupled to the near-eye display 100) to add virtual objects to the captured images or modify physical objects in the captured images, and the processed images may be displayed to the user by the display 110 for augmented reality (AR) and/or mixed reality (MR) applications.

In some examples, the near-eye display 100 may be implemented in any suitable form-factor, in addition to the pair of glasses shown in the figure, such as a head-mounted display (HMD) or other similar wearable eyewear or device. The near-eye display 100 may also include (not shown) one or more eye-tracking systems. As used herein, “eye tracking” may refer to determining an eye’s position or relative position, including orientation, location, and/or gaze of a user’s eye. In some examples, an eye-tracking system may include an imaging system that captures one or more images of an eye and may optionally include a light emitter, which may generate light that is directed to an eye such that light reflected by the eye may be captured by the imaging system. In other examples, the eye-tracking system(s) may capture reflected radio waves emitted by a miniature radar unit. These data associated with the eye may be used to determine or predict eye position, orientation, movement, location, and/or gaze.

As described herein, a virtual object location may be computed for both eyes in the near-eye display 100. Each pupil’s center location may be tracked, and the computed locations aligned to each pupil’s center location to determine a mirror pixel to be used. Using a projector location, a pupil center location, and the mirror pixel’s center as three reference points, a tilt angle for the mirror pixel may be determined to reflect the projection to each eye. The selected mirror pixel may be set to the determined tilt angle, and the projector may be aimed at the mirror pixel’s center. The mirror pixel may reflect the projected image point to the eyes, as a result of which, the user’s brain may create a stereo image point. The system may scan each point on the 2D image similarly projecting the entire image to the eyes.

Functions described herein may be distributed among components of the near-eye display 100 in a different manner than is described here. Furthermore, a near-eye display as discussed herein may be implemented with additional or fewer components than shown in FIG. 1.

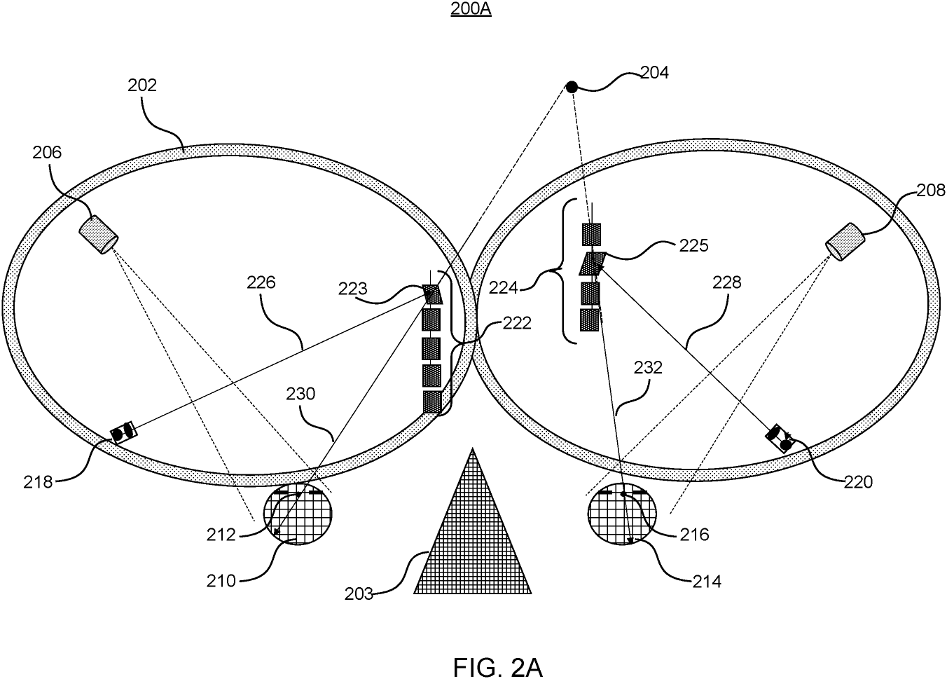

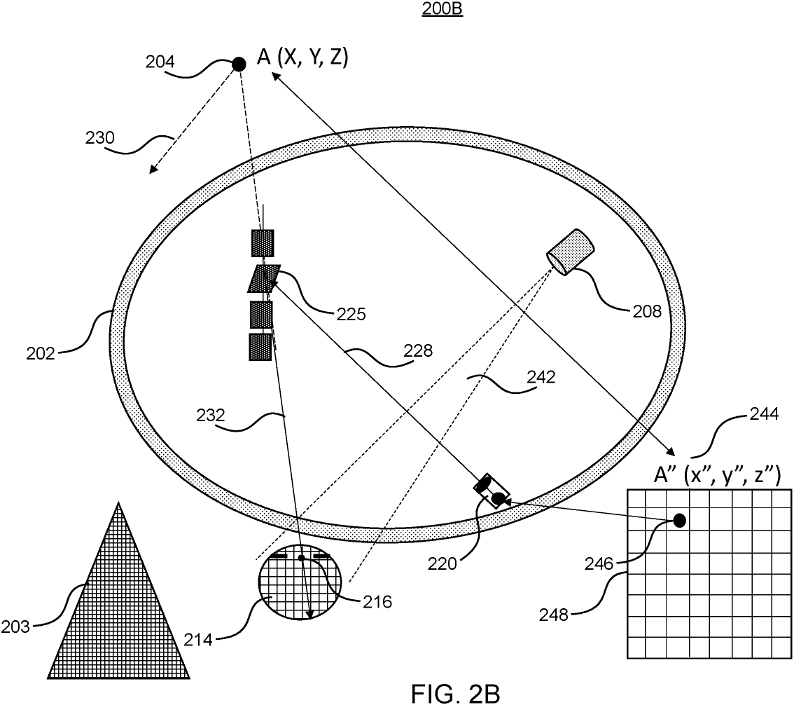

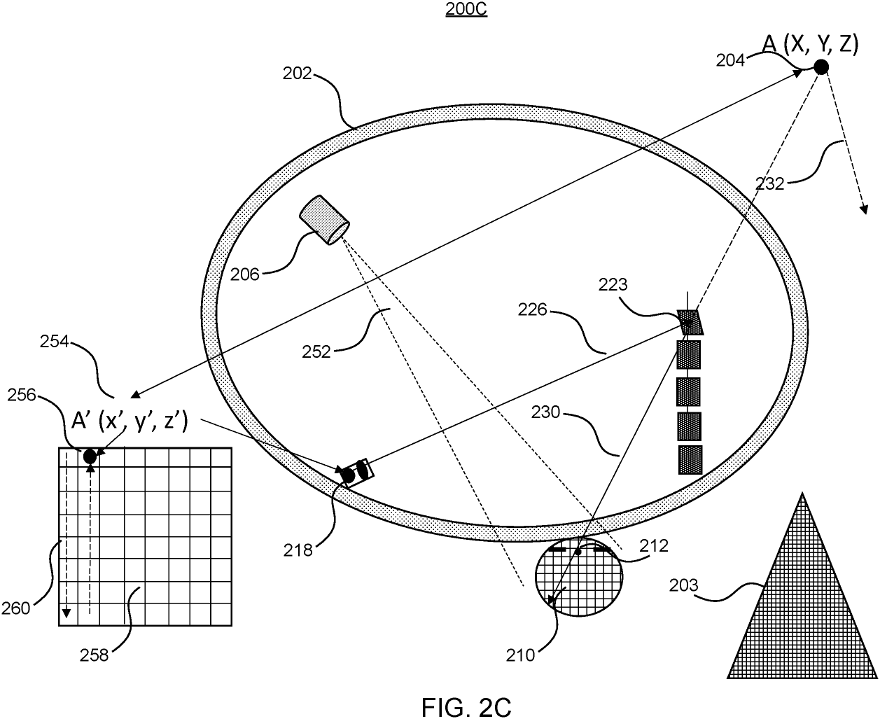

FIGS. 2A-2C illustrate an architecture for near-eye displays with individual mirror angle controllable micromirror array, according to an example. Diagram 200A in FIG. 2A shows a near-eye display frame 202 in front of left eye 210 and right eye 214 with left eye pupil center 212 and right eye pupil center 216, respectively, and nose 203. Also included are left eye tracking camera 206, left projection light source 218, left micromirror array 222, and right eye tracking camera 208, right projection light source 220, right micromirror array 224. A virtual object point location 204 may be determined from scanning of a 2D image (not shown).

In some examples, a left mirror pixel 223 and a tilt angle for the left mirror pixel may be selected based a scanning of the 2D image, the virtual object point location 204, and a tracked position of the left eye pupil center 212. The left mirror pixel 223 may be set to the determined tilt angle and the left projection light source 218 directed to the left mirror pixel 223 such that a collimated beam 226 is projected to the left mirror pixel 223 and then reflected to the left eye 210 as light beam 230. Similarly, a right mirror pixel 225 and a tilt angle for the right mirror pixel may be selected based a scanning of the 2D image, the virtual object point location 204, and a tracked position of the right eye pupil center 216. The right mirror pixel 225 may be set to the determined tilt angle and the right projection light source 220 directed to the right mirror pixel 225 such that a collimated beam 228 is projected to the right mirror pixel 225 and then reflected to the right eye 214 as light beam 232. A collimator may control the collimated beam diameter to be equal or smaller than mirror pixel size to ensure that only one image point uses one mirror pixel for reflection. Thus, the virtual object point may be at infinity for each eye to focus on (although with both eyes receiving the stereo image, the brain may interpret the image as being at a particular distance) and reduce or avoid eye fatigue due to frequent refocusing.

Diagram 200B in FIG. 2B shows the near-eye display frame 202 in front of the right eye 214 with the right eye pupil center 216, and nose 203. Also included are the right eye tracking camera 208, the right projection light source 220, and the right mirror pixel 225 of the right micromirror array. The virtual object point location 204 may be determined from scanning of a 2D image 248.

In some examples, the right mirror pixel 225 and a tilt angle for the right mirror pixel may be selected based a scanning of the 2D image 248, the virtual object point location 204, and the tracked position 242 of the right eye pupil center 216. The right mirror pixel 225 may be set to the determined tilt angle and the right projection light source 220 directed to the right mirror pixel 225 such that a collimated beam 228 is projected to the right mirror pixel 225 and then reflected to the right eye 214 as light beam 232.

In some examples, a virtual image provided to the eyes may be generated from two stereoscopic images (2D image 248 in diagram 200B and 2D image 258 in diagram 200C). The 2D image 248 may be divided into multiple points. Each point on the 2D image 248 may be reflected at different locations in the left eye and the right eye. A″(x″, y″, z″) represents three-dimensional coordinates of the example point 246 in the 2D image 248. Thus, the coordinates A(x, y, z) of the virtual object point location 204 may be derived from A″(x″, y″, z″) and another set of coordinates A′(x′, y′, z′) from the stereoscopic counterpart (2D image 258 shown in diagram 200C) of the 2D image 248. Once the coordinates A(x, y, z) of the virtual object point location 204 are determined and coordinates of the right eye pupil center 216 known (through the eye tracking camera 208), a connecting line between the two sets of coordinates may be computed. Based on the computed line between the two sets of coordinates, one of the right mirror pixels (right mirror pixel 225) may be selected and a tilt angle for the selected mirror pixel determined such that the collimated beam 228 from the right projection light source 220 is reflected into the right eye 214 through the right eye pupil center 216. Computer generated animated stereo images may utilize trigonometric parameters (the eyes’ distances and each side image point deviation from its image center) to compute A(x, y, z) from A′(x′, y′, z′) and A″(x″, y″, z″).

Diagram 200C in FIG. 2C shows the near-eye display frame 202 in front of the left eye 210 with the left eye pupil center 212, and nose 203. Also included are the left eye tracking camera 206, the left projection light source 218, and the left mirror pixel 223 of the left micromirror array. The virtual object point location 204 may be determined from scanning of a 2D image 258.

In some examples, the left mirror pixel 223 and a tilt angle for the left mirror pixel may be selected based a scanning of the 2D image 258, the virtual object point location 204, and the tracked position 252 of the left eye pupil center 212. The left mirror pixel 223 may be set to the determined tilt angle and the left projection light source 218 directed to the left mirror pixel 223 such that a collimated beam 226 is projected to the left mirror pixel 223 and then reflected to the left eye 210 as light beam 230.

As mentioned herein, the virtual image provided to the eyes may be generated from two stereoscopic images (2D image 248 in diagram 200B and 2D image 258 in diagram 200C). The 2D image 258 may be divided into multiple points. A′(x′, y′, z′) 254 represents three-dimensional coordinates of the example point 256 in the 2D image 258. Thus, the coordinates A(x, y, z) of the virtual object point location 204 may be derived from A′(x′, y′, z′) and another set of coordinates A″(x″, y″, z″) from the stereoscopic counterpart (2D image 248 shown in diagram 200B) of the 2D image 258. Once the coordinates A(x, y, z) of the virtual object point location 204 are determined and coordinates of the left eye pupil center 212 known (through the eye tracking camera 206), a connecting line between the two sets of coordinates may be computed. Based on the computed line between the two sets of coordinates, one of the left mirror pixels (left mirror pixel 223) may be selected and a tilt angle for the selected mirror pixel determined such that the collimated beam 226 from the left projection light source 218 is reflected into the left eye 210 through the left eye pupil center 212. An example scan direction 260 is also shown on the 2D image 258 in diagram 200C.

To summarize, a system for a near-eye display with controllable micromirror array may begin with mapping point-by-point coordinates from two stereoscopic images (A′(x′, y′, z′) and A″(x″, y″, z″)) to three dimensional coordinates A(x, y, z) of a virtual object location. For each set of coordinates, a line connecting pupil center of each eye may be computed, where coordinates of the pupil center for each eye may be determined by eye-tracking. Using a location (coordinates) and direction of a projection light source and the computed line for each eye, a mirror pixel in a micromirror array may be selected and a tilt angle for the selected mirror pixel may be set to reflect the collimated beam from the projection light source into each eye through the pupil center. The user’s brain may combine the stereoscopic images to generate the 3D virtual object. By projecting the collimated light into the eye, a need for frequency refocus of the eye may be avoided. A field of view (FOV) of the near-eye display may be determined based on the size of the micromirror array. Thus, bigger FOVs may be achieved by utilizing bigger arrays. Similarly, image resolution may be improved by utilizing smaller micromirror pixels.

In some examples, lines or other groups of points of each of the divided stereoscopic 2D images may be scanned / projected at the same time reducing processing time. Furthermore, multiple projection light sources may be used in coordination for faster reproduction of images in the eyes. Similarly, (especially in cases of line or group scanning, or multiple light projection sources), multiple mirror pixels may be utilized. Thus, two or more mirror pixels may be adjusted for their tilt angle to reflect a large collimated beam or multiple beams at the same time.

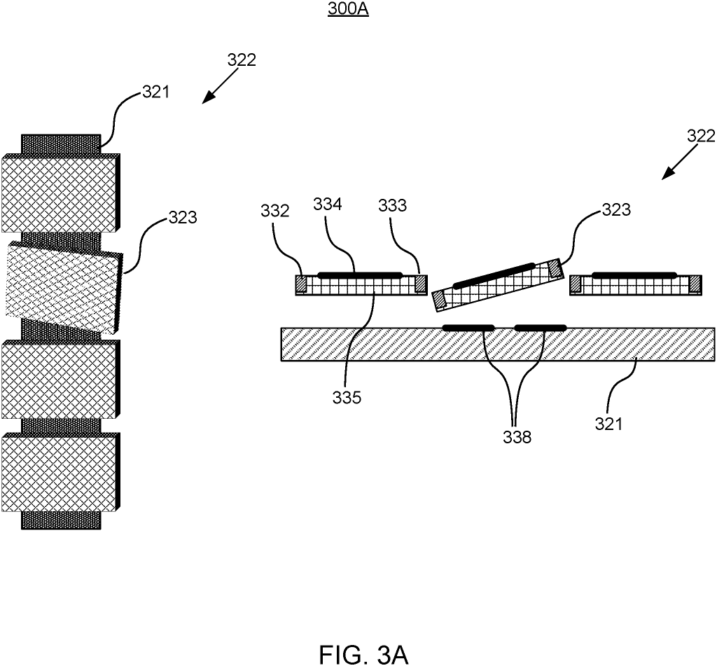

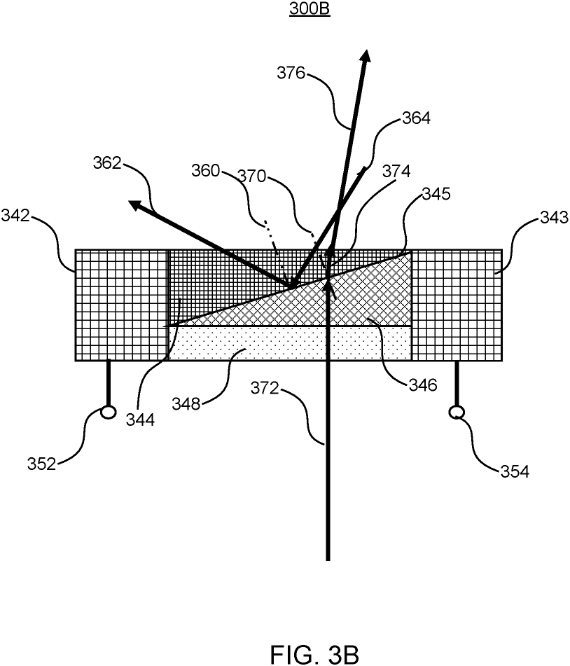

FIG. 3A illustrates an electro-mechanically controllable micromirror array, according to an example. Diagram 300A shows a front view of a micromirror array 322 with tilt angle adjusted mirror 323 and backplate 321. Diagram 300A also includes a side view of the micromirror array 322 with backplate 321 and steering electrodes 338 under each individual mirror. Tilt angle adjusted mirror 323 is shown between two unadjusted mirrors. Each individual mirror may include a substrate 335, two or more springs 332, 333 along the edges of the substrate 335, and reflective surface 334.

In some examples, a position of a selected mirror 323 may be adjusted by applying a predefined voltage to one or more of the electrodes 338 and attracting or repelling corresponding metallic contacts at the bottom surface of the angle adjusted mirror 323. In some examples, a micromirror array including any number of adjustable micromirrors may include a matrix of electrical connections (e.g., on the backplate 321) allowing a processor to select any micromirror within the array and adjust a reflection angle (also called the tilt angle) of the selected micromirror. While the electro-mechanically controllable micromirror array in diagram 300A is shown in two dimensions with the electrodes 338, three-dimensional adjustment may also be achieved by placing four or more electrodes under each micromirror.

FIG. 3B illustrates a microfluidic tunable prism that may be used as a mirror angle controllable micromirror array, according to an example. Diagram 300B shows the microfluidic tunable prism with a combination of lower refraction index liquid 346 higher refraction index liquid 344 filled between electrodes 342, 343 and transparent substrate 348 forming an optical interface 345 between the two liquids. In an operation, a higher voltage 354 may be applied to the electrode 343, and a lower voltage 352 may be applied to the electrode 342. The higher voltage 354 may cause the lower refraction index liquid 346 to accumulate closer to the electrode 343 as the higher refraction index liquid 344 accumulates on the opposite side. Thus, an angle of the optical interface 345 may be modified based, at least in part, on a difference between the lower voltage 352 and the higher voltage 354.

In some examples, a pass-through light beam 372 arriving at the transparent substrate 348 may pass through the substrate and the lower refraction index liquid 346 without any refraction, then get refracted (374) based on a difference of refraction indices of the two liquids and exit into air as light beam 374 refracting some more based on a difference of refraction indices of the higher refraction index liquid 344 and air. A light beam 364 arriving at the surface of the higher refraction index liquid 344 may be subject to total internal reflection (TIR) at the optical interface 345 and reflect out of the higher refraction index liquid 344 as light beam 362.

Accordingly, a reflection angle of a light beam arriving on a liquid surface of the tunable microfluid mirror and an angle of another light beam passing through the transparent microfluidic mirror may be adjusted by adjusting values of the lower and/or higher voltages 352, 354. A micromirror array including any number of tunable microfluidic mirrors may include a matrix of electrical connections allowing a processor to select any micromirror within the array and adjust a reflection angle (also called the tilt angle) of the selected micromirror. While the tunable microfluid mirror in diagram 300B is shown in two dimensions with the electrodes 342 and 343 on either side, three-dimensional adjustment may also be achieved by placing four or more electrodes on four or more sides of the micromirror.

The electro-mechanically controllable micromirror array and a microfluidic tunable prism array in FIGS. 3A and 3B are illustrative examples of a micromirror array that may be used in a near-eye display device as described herein. Other mirror types such as digital micromirror arrays may also be implemented using the principles described herein.

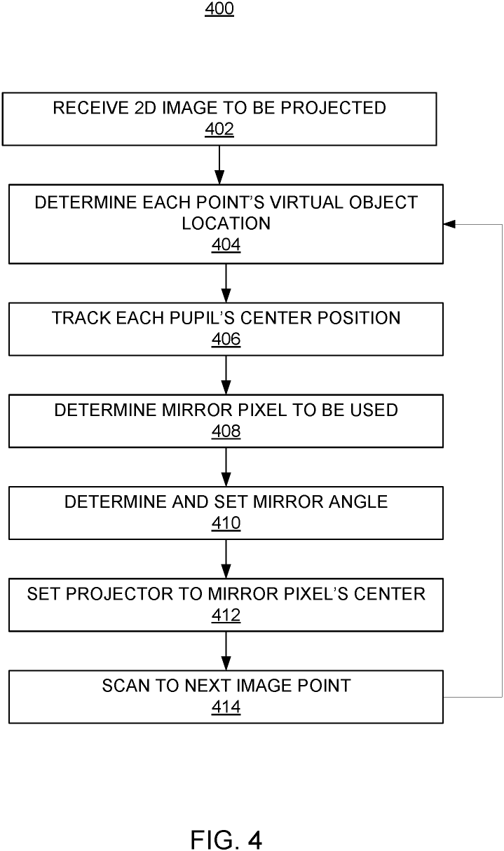

FIG. 4 illustrates a flowchart of a method for providing virtual reality (VR) content, augmented reality (AR) content, or mixed reality (MR) content through a near-eye display with mirror angle control, according to an example. The method 400 is provided by way of example, as there may be a variety of ways to carry out the method described herein. Although the method 400 is primarily described as being performed by the devices of FIGS. 2A-2B, the method 400 may be executed or otherwise performed by one or more processing components of another system or a combination of systems. Each block shown in FIG. 4 may further represent one or more processes, methods, or subroutines, and one or more of the blocks (e.g., the selection process) may include machine readable instructions stored on a non-transitory computer readable medium and executed by a processor or other type of processing circuit to perform one or more operations described herein.

At block 402, a set of 2D stereoscopic images to be projected may be received at a near-eye display system processor. The stereoscopic images may be used to create a 3D virtual image (or object). At block 404, coordinates of each point of the 3D virtual object may be determined based, at least in part, on coordinates of corresponding points in the stereoscopic 2D images.

At block 406, each pupil’s center position may be determined by using an eye tracking camera, for example. The pupil center position may be determined for each coordinate set in the 3D virtual object A(x, y, z). At block 408, a mirror pixel in the micromirror array may be selected based on an alignment of the coordinate set in the 3D virtual object A(x, y, z) and corresponding pupil center coordinates for each eye.

At block 410, a tilt angle for the selected mirror pixel may be determined using coordinates of the light projection source, pupil center coordinates, and coordinates of a center of the selected mirror pixel. The selected mirror pixel for each eye may then be set to the determined tilt angle for that eye. At block 412, the light projection source for each eye may be directed to the center of the selected mirror pixel and a collimated beam based on the point in the stereoscopic 2D image projected to the mirror pixel. The selected mirror pixels for each eye may reflect the collimated beam to respective eyes through the pupil centers. The received stereoscopic images may be interpreted by the brain as a 3D virtual object.

At block 414, a subsequent point in each of the stereoscopic 2D images may be scanned and processing returned to block 404 for determination of corresponding coordinates for the 3D virtual object. Each of the processing steps discussed herein may be performed for the left eye and the right eye to take advantage of the stereoscopic image interpretation by the brain. Furthermore, as discussed herein, line or group scanning may also be performed instead of point-by-point scanning for faster rendering of 3D objects.

According to examples, a method of making the near-eye display is described herein. A system of making the near-eye display is also described herein. A non-transitory computer-readable storage medium may have an executable stored thereon, which when executed instructs a processor to perform the methods described herein.

In the foregoing description, various inventive examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example’ is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. A near-eye display device, comprising:
a camera to track a location of a center of an eye pupil;
a projection light source to provide a collimated beam; and
a micromirror array comprising a plurality of adjustable micromirror pixels, wherein
a micromirror pixel is selected from the micromirror array based on a first coordinate set determined for a point on a three-dimensional (3D) virtual object and a second coordinate set determined for a center of the eye pupil,
the selected micromirror pixel is set to a tilt angle determined based, at least in part, on the first coordinate set, the second coordinate set, and a location of the projection light source,
a direction of the projection light source is set to a center of the selected micromirror pixel, and
a collimated beam transmitted from the projection light source to the center of the selected micromirror pixel.

2. The near-eye display device of claim 1, wherein the projection light source is to transmit the collimated beam to the center of the selected micromirror pixel such that the collimated beam is reflected to the center of the eye pupil in alignment with a computed line from the first coordinate set to the center of the eye pupil.

3. The near-eye display device of claim 1, wherein
the projection light source is rotatable along three axes; and
the micromirror array comprises an electromechanically adjustable micromirror array or a tunable microfluidic micromirror array.

4. A near-eye display device, comprising:
for each eye of a user wearing the near-eye display device:
a camera to track a location of a center of an eye pupil;
a projection light source to provide a collimated beam;
a micromirror array comprising a plurality of adjustable micromirror pixels; and
a processor communicatively coupled to the camera, the projection light source, and the micromirror array, the processor to:
determine a first coordinate set for a point on a three-dimensional (3D) virtual object and a second coordinate set for a center of the eye pupil;
select a micromirror pixel from the micromirror array based on the first coordinate set and the second coordinate set;
determine a tilt angle for the selected micromirror pixel based, at least in part, on the first coordinate set, the second coordinate set, and a location of the projection light source;
set the selected micromirror pixel to the determined tilt angle;
set a direction of the projection light source to a center of the selected micromirror pixel; and
cause the projection light source to transmit a collimated beam to the center of the selected micromirror pixel.

5. The near-eye display device of claim 4, wherein the processor is to determine:
the first coordinate set for the point on the 3D virtual object for a left eye based on coordinates of a first point on a first two-dimensional (2D) image for the left eye; and
the first coordinate set for the point on the 3D virtual object for a right eye based on coordinates of a second point on a second 2D image for the right eye, wherein the first 2D image and the second 2D image are stereoscopic.

6. The near-eye display device of claim 4, wherein the processor is to determine:
the first coordinate set for a plurality of points on the 3D virtual object for a left eye based on coordinates of a first plurality of points on a first two-dimensional (2D) image for the left eye; and
the first coordinate set for a plurality of points on the 3D virtual object for a right eye based on coordinates of a second plurality of points on a second 2D image for the right eye, wherein the first 2D image and the second 2D image are stereoscopic.

7. The near-eye display device of claim 6, wherein the first plurality of points on the first 2D image and the second plurality of points on the second 2D image are lines.

8. The near-eye display device of claim 4, wherein
the projection light source is rotatable along three axes; and
the micromirror array comprises an electromechanically adjustable micromirror array or a tunable microfluidic micromirror array.

9. The near-eye display device of claim 4, wherein the processor is to cause the projection light source to transmit the collimated beam to the center of the selected micromirror pixel such that the collimated beam is reflected to the center of the eye pupil in alignment with a computed line from the first coordinate set to the center of the eye pupil.

10. The near-eye display device of claim 4, further comprising a plurality of projection light sources, wherein the processor is to:
set a direction of the plurality of projection light sources to the center of the selected micromirror pixel; and
cause the plurality of projection light sources to transmit a plurality of collimated beams to the center of the selected micromirror pixel.

11. The near-eye display device of claim 4, wherein the processor is to:
select a plurality of micromirror pixels from the micromirror array based on the first coordinate set and the second coordinate set;
determine a tilt angle for each of the selected plurality of micromirror pixels based, at least in part, on the first coordinate set, the second coordinate set, and the location of the projection light source; and
set the selected plurality of micromirrors pixel to the respective determined tilt angles.

12. A method for a near-eye display device, comprising:
for each eye of a user wearing the near-eye display device:
determining, at a processor, a first coordinate set for a point on a three-dimensional (3D) virtual object;
tracking, at an eye tracking camera, a center of an eye pupil;
determining, at the processor, a second coordinate set for a center of the eye pupil;
selecting, at the processor, a micromirror pixel from a micromirror array based on the first coordinate set and the second coordinate set;
determining, at the processor, a tilt angle for the selected micromirror pixel based, at least in part, on the first coordinate set, the second coordinate set, and a location of a projection light source;
setting, at the micromirror array, the selected micromirror pixel to the determined tilt angle;
setting, at the projection light source, a direction of the projection light source to a center of the selected micromirror pixel; and
transmitting, at the projection light source, a collimated beam to the center of the selected micromirror pixel.

13. The method of claim 12, further comprising:
determining the first coordinate set for the point on the 3D virtual object for a left eye based on coordinates of a first point on a first two-dimensional (2D) image for the left eye; and
determining the first coordinate set for the point on the 3D virtual object for a right eye based on coordinates of a second point on a second 2D image for the right eye, wherein the first 2D image and the second 2D image are stereoscopic.

14. The method of claim 12, further comprising:
determining the first coordinate set for a plurality of points on the 3D virtual object for a left eye based on coordinates of a first plurality of points on a first two-dimensional (2D) image for the left eye; and
determining the first coordinate set for a plurality of points on the 3D virtual object for a right eye based on coordinates of a second plurality of points on a second 2D image for the right eye, wherein the first 2D image and the second 2D image are stereoscopic.

15. The method of claim 14, wherein the first plurality of points on the first 2D image and the second plurality of points on the second 2D image are lines.

16. The method of claim 12, wherein setting the direction of the projection light source to the center of the selected micromirror pixel comprises:
rotating the projection light source along at least one of three axes.

17. The method of claim 12, wherein the micromirror array comprises an electromechanically adjustable micromirror array or a tunable microfluidic micromirror array.

18. The method of claim 12, wherein transmitting the collimated beam to the center of the selected micromirror pixel comprises:
transmitting the collimated beam to the center of the selected micromirror pixel such that the collimated beam is reflected to the center of the eye pupil in alignment with a computed line from the first coordinate set to the center of the eye pupil.

19. The method of claim 12, wherein the near-eye display device comprises a plurality of projection light sources, and the method further comprises:
setting a direction of the plurality of projection light sources to the center of the selected micromirror pixel; and
transmitting a plurality of collimated beams to the center of the selected micromirror pixel.

20. The method of claim 12, further comprising:
selecting a plurality of micromirror pixels from the micromirror array based on the first coordinate set and the second coordinate set;
determining a tilt angle for each of the selected plurality of micromirror pixels based, at least in part, on the first coordinate set, the second coordinate set, and the location of the projection light source; and
setting the selected plurality of micromirrors pixel to the respective determined tilt angles.
